(19) United States
(12) Patent Application Publication
(10) Pub. No.: US 2014/0159992 A1
(43) Pub. Date: Jun. 12, 2014

(54) ADJUSTING A DISPLAY WALL THROUGH A PORTABLE DEVICE

(71) Applicant: HON HAI PRECISION INDUSTRY CO., LTD., New Taipei (TW)

(72) Inventors: YI-WEN CAI, New Taipei (TW); CHUN-MING CHEN, New Taipei (TW); CHUNG-I LEE, New Taipei (TW)

(73) Assignee: HON HAI PRECISION INDUSTRY CO., LTD., New Taipei (TW)

(21) Appl. No.: 13/887,419

(22) Filed: May 6, 2013

(30) Foreign Application Priority Data
Dec. 11, 2012 (TW) 101146492

(51) Int. Cl. G06F 3/14

(52) U.S. Cl. CPC G06F 3/1446
USPC 345/2.3

(57) ABSTRACT

A display wall can be adjusted by using a portable device including an image sensing unit, a wireless communication unit communicating with the display wall through a wireless communication network, and a control unit. The image sensing unit produces image(s) of the display devices within the display wall. The control unit analyzes the image(s) to obtain a display parameter, for example, the actual brightness of each of the display devices, and produces control information according to the display parameters of the display devices. The portable device transmits the control information to the display wall, such that the display parameter of the display wall can be adjusted overall according to the control information, by synchronizing the display parameters of the individual display devices.

### BACKGROUND

1. Technical Field

The present disclosure relates to a display wall adjusting device for a display wall with a plurality of displays, and particularly to a portable display wall adjusting device, which is capable of synchronizing the display parameters of the displays of the display wall.

2. Description of Related Art

Display walls with a plurality of displays are often used for larger display screens because of their characteristics such as high-definition and easy-installation. For the sake of equalizing the efficiency of the displays, the displays of a single type are generally used. However, the efficiency of the displays may not be identical because of differences in the physical characteristics or the degree of degradation of the components of the displays.

Since the problem of inaccuracy can emerge when estimating the differences among the efficiency of the displays by the naked eye, specific measuring devices with photo diodes are generally used, which is inconvenient for users without the specific measuring devices.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a display wall adjusting device of the present disclosure.

FIG. 2 is a schematic view of an embodiment of a graphic user interface (GUI) displayed through a display unit of the display wall adjusting device of FIG. 1.

FIG. 3A/3B/3C is a flowchart of an embodiment of a display wall adjusting method implemented through the display wall adjusting device of FIG. 1.

### DETAILED DESCRIPTION

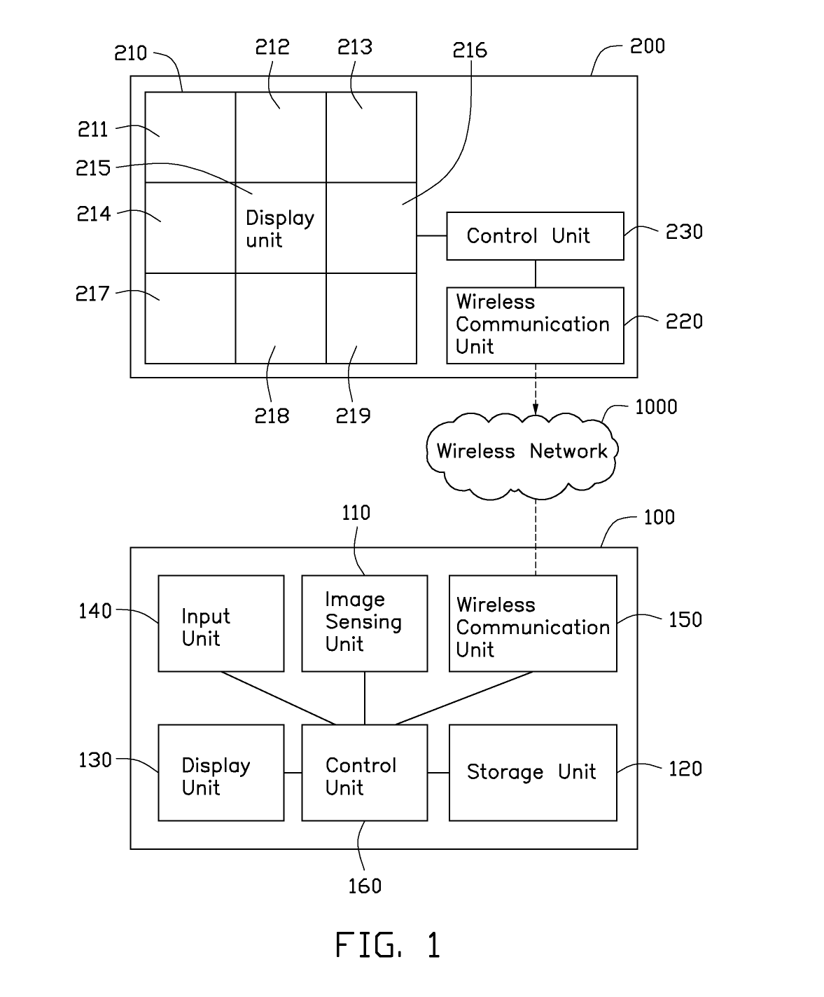

FIG. 1 is a block diagram of an embodiment of a display wall adjusting device 100 of the present disclosure. In the illustrated embodiment, the display wall adjusting device 100 is a portable device such as a smart phone or a tablet computer. In other embodiments, the display wall adjusting device 100 can be another type of portable device such as a notebook computer. The display wall adjusting device 100 communicates with a display apparatus 200 through a wireless network 1000 such as a short distance wireless network implemented according to, for example, the BLUETOOTH telecommunication standard.

The display apparatus 200 includes a display unit 210 with display devices 211-219, a wireless communication unit 220, and a control unit 230. The display unit 210 is a display wall while each of the display devices 211-219 is a display such as a television. The wireless communication unit 220 communicates with the display wall adjusting device 100 through the wireless network 1000. The control unit 230 which may include graphics card(s) controls the display unit 210 to display image(s) individually through one of the display devices 211-219, or to display the image(s) jointly through a portion or through all of the display devices 211-219.

The display wall adjusting device 100 includes an image sensing unit 110, a storage unit 120, a display unit 130, an input unit 140, a wireless communication unit 150, and a control unit 160. The image sensing unit 110 may include a camera including, for example, charge coupled device (CCD) or complementary metal oxide semiconductor (CMOS) image sensors, which can be used to photograph the display apparatus 200. In the illustrated embodiment, the image sensing unit 110 produces image(s) of the screen of each of the display devices 211-219 by, for example, placing the lens of the image sensing unit 110 on or close to the screen of each of the display devices 211-219. In other embodiments, the image sensing unit 110 may produce image(s) of a full or overall view of all the display devices 211-219 by, for example, placing the lens of the image sensing unit 110 a certain distance from the display devices 211-219, wherein the certain distance allows the image sensing unit 110 to produce image(s) of the plurality of display devices 211-219. The image(s) are then stored in the storage unit 120, wherein the storage unit 120 may include a storage device such as a random access memory, a non-volatile memory, or a hard disk drive.

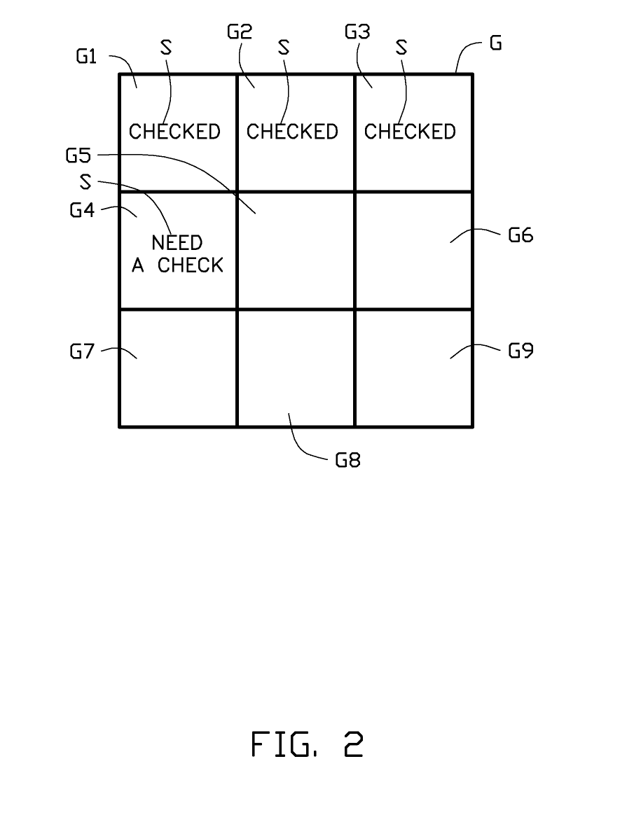

FIG. 2 is a schematic view of an embodiment of a graphic user interface (GUI) G displayed through the display unit 130 of the display wall adjusting device 100 of FIG. 1. The display unit 130 may include a display device such as a liquid crystal display (LCD). In the illustrated embodiment, the display unit 130 is controlled by the control unit 160 to display the GUI G corresponding to the display apparatus 200 according to an application software stored in the storage unit 120 and executed by the control unit 160. The application software includes instructions for displaying the GUI G including blocks G1-G9 and symbols S. The blocks G1-G9 represent the respective display devices 211-219 of the display apparatus 200. The symbols S may include a label or an icon which indicates the photographic requirement of the display devices 211-219 by, for instance, differentiating among the photographed item(s) and the item to be photographed, thereby directing a user to photograph the display devices 211-219 in a particular sequence. The input unit 140 may include an input device such as a touch panel. The user can use the input unit 140 to issue a photographing instruction for enabling the image sensing unit 110 to produce the image(s). The user can also use the input unit 140 to change the sequence of photographing the display devices 211-219 by, for instance, indicating the next display device 211-219 to be photographed. The display wall adjusting device 100 communicates with the display apparatus 200 through the wireless communication unit 150.

The control unit 160 analyzes the image(s) of each of the display devices 211-219 or a full view of all the display devices 211-219, thereby obtaining a display parameter Pd (not shown) with respect to each of the display devices 211-219. The display parameter Pd can be configured through editing configuration information of each of the display devices 211-219. The display parameter Pd can represent color, contrast, white balance, sharpness, grayscale, or other type of display variable of each of the display devices 211-219.

In the illustrated embodiment, the configuration information corresponding to the display parameters Pd of the display devices 211-219 are all configured to a same value before producing the image(s) of each of the display devices 211-219, thereby obtaining the actual display parameter Pd of each of the display devices 211-219 based on a same configuration. The display parameter Pd represents the actual brightness of each of the display devices 211-219. In other embodiments, the display parameter Pd of each of the display devices 211-219 can be configured to the maximum value before producing the image(s) of each of the display devices 211-219, thereby obtaining the maximum display parameter Pd of each of the display devices 211-219, and a range of the actual display parameter Pd of each of the display devices 211-219 can be obtained.

The control unit 160 further produces control information Ic (not shown) according to the display parameters Pd of the display devices 211-219. The control information Ic may include configuration information for configuring the display parameter Pd of each of the display devices 211-219, for example, a percentage value representing the brightness configuration of each of the display devices 211-219. In the illustrated embodiment, the control unit 160 determines a standard display parameter Ps (not shown) according to the display parameters Pd of the display devices 211-219. The control unit 160 further produces the control information Ic according to a difference between the display parameter Pd of each of the display devices 211-219 and the standard display parameter Ps, such that the display apparatus 200 is able to compensate for any difference between the display parameter Pd of the corresponding display device 211-219 and the standard display parameter Ps according to the control information Ic.

For instance, when the display parameter Pd represents the actual brightness of one of the display devices 211-219, the control unit 160 produces the control information Ic for increasing the brightness of the corresponding display device 211-219 when the actual brightness is lower than the brightness represented by the standard display parameter Ps, or produces the control information Ic for decreasing the brightness of the corresponding display device 211-219 when the actual brightness is higher than the brightness represented by the standard display parameter Ps, such that the display apparatus 200 can compensate for any difference between the brightness of the corresponding display device 211-219 and the brightness represented by the standard display parameter Ps according to the control information Ic.

In the illustrated embodiment, the control unit 160 automatically determines the minimum value among the display parameters Pd of the display devices 211-219 as the standard display parameter Ps. For instance, when the display parameter Pd represents the actual brightness of the display device 211-219, the control unit 160 determines the lowest level of brightness among the brightness of all the display devices 211-219 as the standard display parameter Ps. In other embodiments, the control unit 160 can determine other values such as the average value among the display parameters Pd of the display devices 211-219 as being the standard display parameter Ps, while recommended display parameter(s) such as a range of display parameter can be displayed through the display unit 130 to allow the user to enter the standard display parameter Ps manually through the input unit 140.

The display wall adjusting device 100 transmits the control information Ic to the display apparatus 200 through the wireless network 1000, while the display apparatus 200 receives the control information Ic through the wireless communication unit 220 connected to the wireless network 1000. The control unit 230 adjusts the display parameter Pd of each display device 211-219 according to the control information Ic, thereby compensating for any difference between the display parameter Pd of each display device 211-219 and the standard display parameter Ps. For instance, when the display parameter Pd represents the actual brightness of each of the display devices 211-219, the control unit 230 increases the brightness of each of the display devices 211-219 as necessary according to the control information Ic when the actual brightness is lower than the brightness corresponding to the standard display parameter Ps The control unit 230 decreases the brightness of each of the display devices 211-219 as necessary according to the control information Ic when the actual brightness is higher than the brightness corresponding to the standard display parameter Ps, thereby compensating for any difference between the brightness of each of the display devices 211-219 and the brightness represented by the standard display parameter Ps.

After the differences with regard to all of the display devices 211-219 are equalized or compensated according to the control information Ic of the display devices 211-219, the display parameters Pd of the display devices 211-219 are synchronized. In addition, the adjusted display parameter Pd can be verified by, for example, displaying the GUI G with the symbols S indicating the display device 211-219 corresponding to the adjusted display parameter Pd on the display unit 130, thereby directing the user to photograph one or more of the corresponding display device(s) 211-219 and obtain the adjusted display parameter Pd by analyzing the image(s) of the corresponding display device(s) 211-219.

In the illustrated embodiment, the display wall adjusting device 100 transmits a display information Id (not shown) to the display apparatus 200, thereby enabling the display device(s) 211-219 of the display apparatus 200 to display a test image according to the display information Id, wherein the test image is an image suitable for revealing or suggesting or clarifying the display parameters Pd which need to be obtained. For instance, when the display parameter Pd represents the actual brightness of each of the display devices 211-219, the test image can be an all-white image, such that the white light brightness emitted by the screen of the display device 211-219 can be obtained.

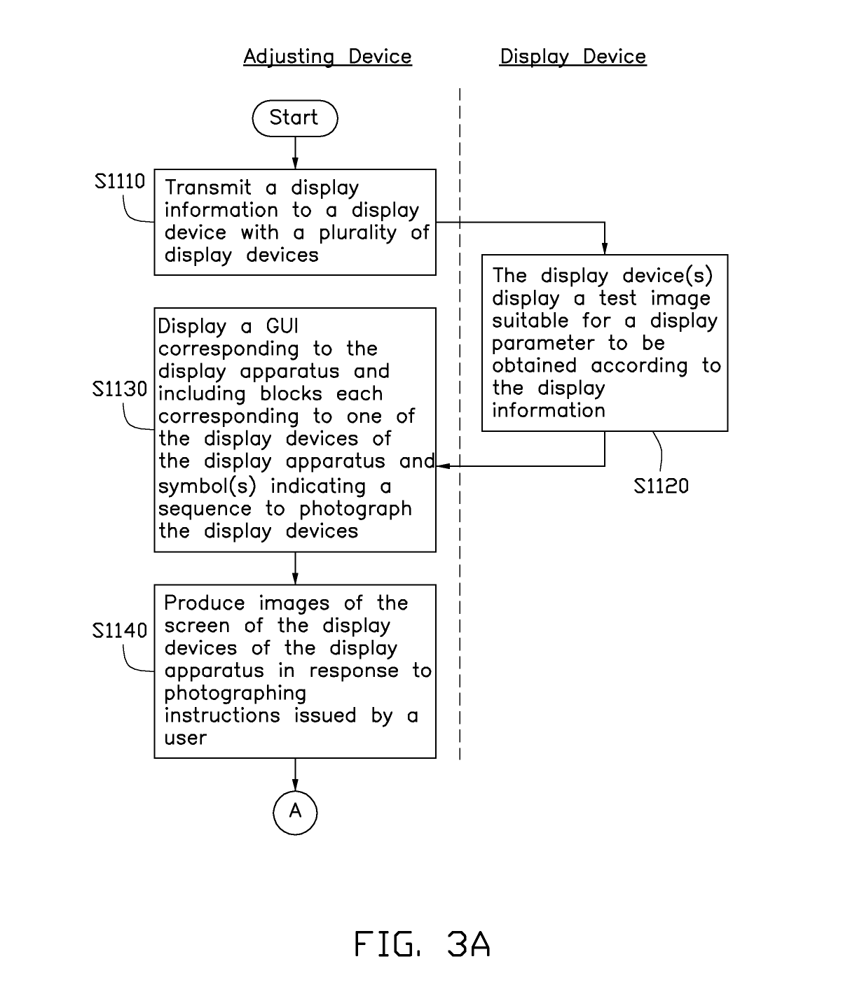

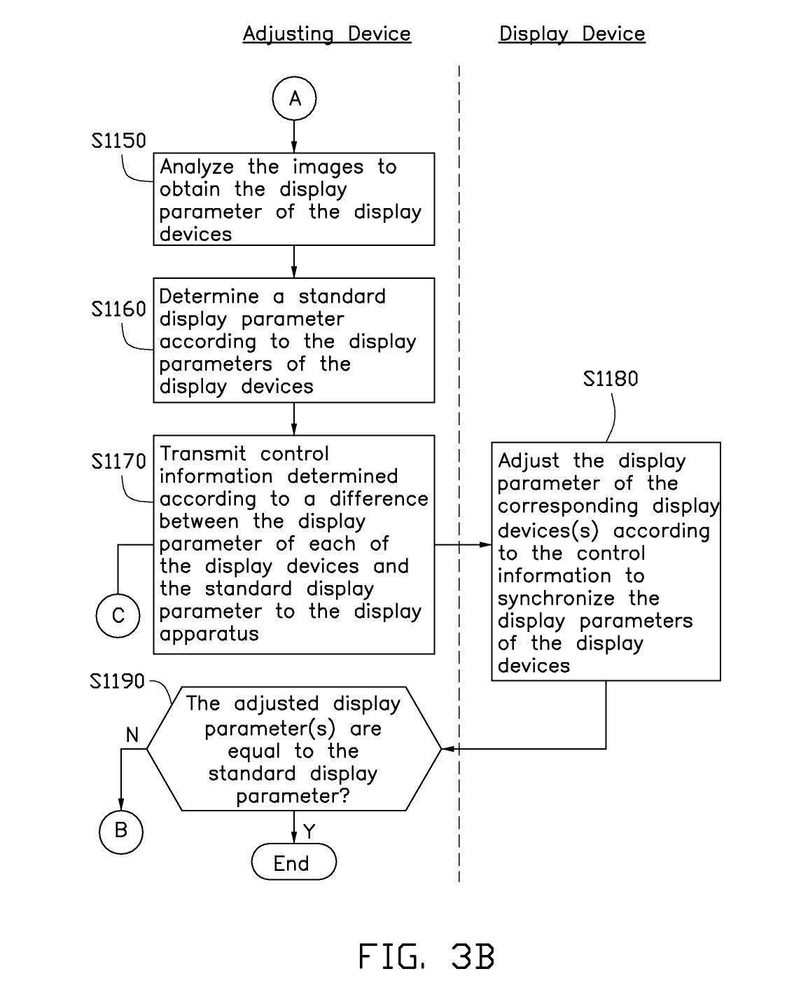

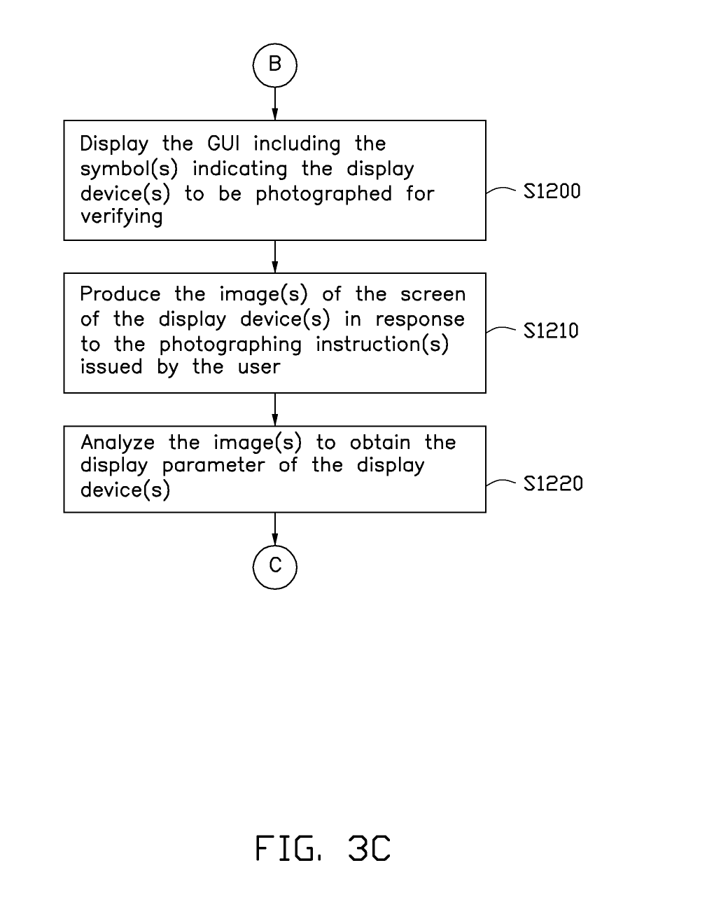

FIG. 3A/3B/3C is a flowchart of an embodiment of a display wall adjusting method implemented through the display wall adjusting device 100 of FIG. 1. The display wall adjusting method of the present disclosure is as follows. Steps S1110, S1130-S1170, and S 1190 are implemented through instructions stored in the storage unit 120 of the display wall adjusting device 100. Depending on the embodiment, additional steps may be added, others removed, and the ordering of the steps may be changed.

In step S1110, the display information Id is transmitted to the display apparatus 200 with the display devices 211-219 through the wireless communication network 1000, wherein the display devices 211-219 of the display apparatus 200 can display image(s) individually through one of the display devices 211-219 or display the image(s) jointly through a portion or through all of the display devices 211-219.

In step S1120, a test image suitable for the display parameter Pd to be obtained is displayed according to the display information Id by the display device(s) 211-219 of the display apparatus 200. In the illustrated embodiment, the display parameter Pd represents the actual brightness of each of the display devices 211-219. In other embodiments, the display parameter Pd can represent the color, the contrast, the white balance, the sharpness, the grayscale, or other types of display parameter of each of the display devices 211-219.

In step S1130, the graphic user interface G corresponding to the display apparatus 200 is displayed, wherein the GUI G includes blocks G1-G9 each corresponding to an individual display device 211-219 of the display apparatus 200 and the symbol(s) S indicating a sequence for photographing the display devices 211-219.

In step S1140, the images of the screen of the display devices 211-219 of the display apparatus 200 are produced in response to photographing instructions issued by a user. In the illustrated embodiment, the images of the screen of each of the display devices 211-219 are produced. In other embodiments, image(s) of a full or overall view of all the display devices 211-219 can be produced.

In step S1150, the images are analyzed to obtain the display parameter Pd of the display devices 211-219.

In step S1160, the standard display parameter Ps is determined according to the display parameters Pd of the display devices 211-219.

In step S1170, the control information Ic is determined according to a difference between the display parameter Pd of each of the display devices 211-219 and the standard display parameter Ps and is transmitted to the display apparatus 200 through the wireless communication network 1000. In the illustrated embodiment, the smallest value among the display parameters Pd of the display devices 211-219 is determined as being the standard display parameter Ps. In other embodiments, other values such as the average value among the display parameters Pd of the display devices 211-219 can be determined as being the standard display parameter Ps.

In step S1180, the display parameter Pd of the corresponding display device(s) 211-219 is adjusted according to the control information Ic, thereby synchronizing the display parameters Pd of the display devices 211-219.

In step S1190, the adjusted display parameter(s) Pd are determined. If the adjusted display parameter(s) Pd are not equal to the standard display parameter, step 51200 is implemented, thereby verifying the adjusted display parameter Pd. Otherwise, the method is terminated.

In step S1200, the graphic user interface G including the symbol(s) S indicating the display device(s) 211-219 to be photographed for verifying, is displayed.

In step S1210, the image(s) of the screen of the display device(s) 211-219 are produced in response to the photographing instruction(s) issued by the user.

In step S1220, the image(s) are analyzed to obtain the display parameter Pd of the display device(s) 211-219.

In the display wall adjusting device and the display wall adjusting method, since a display parameter of display(s) of a display wall is adjusted according to a control information, for compensating for any difference between the display parameter of the individual display and a standard display parameter, the display parameters of the displays are therefore synchronized, and the visual impact and efficiency of the individual displays are equalized.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A portable display wall adjusting device communicating with a display apparatus comprising a plurality of display devices through a wireless communication network, the portable display wall adjusting device comprising:
an image sensing unit producing one or more images corresponding to the display devices of the display apparatus, wherein the display apparatus selectively displays one or more images individually and jointly through at least a portion of the display devices;
a wireless communication unit communicating with the display apparatus through the wireless communication network; and
a control unit, wherein the control unit analyzes the one or more images to obtain a display parameter of each of the display devices and produces control information according to the display parameters of the display devices;
wherein the portable display wall adjusting device transmits the control information to the display apparatus to enable the display apparatus to adjust the display parameter of at least one of the display devices according to the control information to substantially synchronize the display parameters of the display devices.

2. The portable display wall adjusting device of claim 1, wherein the control unit determines a standard display parameter according to the display parameters of the display devices and produces the control information according to a difference between the display parameter of each of the display devices and the standard display parameter.

3. The portable display wall adjusting device of claim 2, wherein the control unit determines the standard display parameter to correspond to the minimum value among the display parameters of the displays.

4. The portable display wall adjusting device of claim 1, further comprising a display unit displaying a graphic user interface (GUI) corresponding to the display apparatus, the GUI comprises a plurality of blocks each corresponding to one of the display devices of the display apparatus and one or more symbols indicating a sequence to photograph the display.

5. The portable display wall adjusting device of claim 1, wherein the control unit transmits a display information to the display apparatus to enable at least a portion of the displays of the display apparatus to display a test image corresponding to the display parameter according to the display information.

6. The portable display wall adjusting device of claim 1, wherein the image sensing unit produces the one or more images corresponding to a full view of the displays.

7. The portable display wall adjusting device of claim 1, wherein the display parameter is one of brightness, color, contrast, white balance, sharpness, and grayscale of each display device.

8. A display wall adjusting method for a portable device, comprising:
producing one or more images corresponding to displays of a display apparatus selectively displaying one or more images individually and jointly through at least a portion of the displays;
analyzing the one or more images to obtain a display parameter of each of the displays;
producing control information according to the display parameters of the displays; and
transmitting the control information to the display apparatus through a wireless communication network to enable the display apparatus to adjust the display parameter of at least one of the displays according to the control information to substantially synchronize the display parameters of the displays.

9. The display wall adjusting method of claim 8, wherein the step of producing the control information comprises:
determining a standard display parameter according to the display parameters of the displays; and
producing the control information according to a difference between the display parameter of each of the display devices and the standard display parameter.

10. The display wall adjusting method of claim 9, wherein the step of determining the standard display parameter comprises:
determining the standard display parameter to correspond to the minimum value among the display parameters of the displays.

11. The display wall adjusting method of claim 8, further comprising:
displaying a graphic user interface (GUI) corresponding to the display apparatus, the GUI comprising a plurality of blocks each corresponding to one of the display devices of the display apparatus and one or more symbols indicating a sequence to photograph the display.

12. The display wall adjusting method of claim 8, further comprising:
transmitting a display information to the display apparatus through the wireless communication network to enable at least a portion of the displays of the display apparatus to display a test image corresponding to the display parameter according to the display information.

13. The display wall adjusting method of claim 8, wherein the step of producing the one or more images comprises:
producing the one or more images corresponding to a full view of the displays.

14. The display wall adjusting method of claim 8, wherein the display parameter is one of brightness, color, contrast, white balance, sharpness, and grayscale of each display device.
